(19) United States
(12) Patent Application Publication
(10) Pub. No.: US 2016/0019060 A1
(43) Pub. Date: Jan. 21, 2016

(54) ENFORCING LOOP-CARRIED DEPENDENCY (LCD) DURING DATAFLOW EXECUTION OF LOOP INSTRUCTIONS BY OUT-OF-ORDER PROCESSORS (OOPs), AND RELATED CIRCUITS, METHODS, AND COMPUTER-READABLE MEDIA

(71) Applicant: QUALCOMM Incorporated, San Diego, CA (US)

(72) Inventors: Karamvir Singh Chatha, San Diego, CA (US); Michael Alexander Howard, Cardiff, CA (US); Rick Seokyong Oh, San Diego, CA (US); Ramesh Chandra Chauhan, San Diego, CA (US)

(21) Appl. No.: 14/485,868

(22) Filed: Sep. 15, 2014

Related U.S. Application Data
(60) Provisional application No. 62/026,749, filed on Jul. 21, 2014.

(51) Int. Cl. G06F 9/30

(52) U.S. Cl. CPC G06F 9/30065; G06F 9/30145

(57) ABSTRACT

Enforcing loop-carried dependency (LCD) during dataflow execution of loop instructions by out-of-order processors (OOPs), and related circuits, methods, and computer-readable media, is disclosed. In one aspect, a reservation station circuit is provided, comprising one or more reservation station segments configured to store a consumer loop instruction. Each reservation station segment also includes an operand buffer for each operand of the consumer loop instruction, the operand buffer indicating a producer loop instruction and an LCD distance between the producer loop instruction and the consumer loop instruction. Each reservation station segment receives an execution result of the producer loop instruction, and a loop iteration indicator that indicates a current loop iteration for the producer loop instruction. The reservation station segment generates an operand buffer index based on the loop iteration indicator of the producer loop instruction and the LCD offset indicator of the operand buffer corresponding to the execution result.

### PRIORITY CLAIM

The present application claims priority to U.S. Provisional Patent Application Ser. No. 62/026,749 filed on Jul. 21, 2014 and entitled “ENFORCING LOOP-CARRIED DEPENDENCY (LCD) DURING DATAFLOW EXECUTION OF LOOP INSTRUCTIONS BY OUT-OF-ORDER PROCESSORS (OOPs), AND RELATED CIRCUITS, METHODS, AND COMPUTER-READABLE MEDIA,” which is incorporated herein by reference in its entirety.

### BACKGROUND

I. Field of the Disclosure

The technology of the disclosure relates generally to dataflow execution of loop instructions by out-of-order processors (OOPs).

II. Background

Many modern computers incorporate out-of-order processors (OOPs) that are capable of dataflow execution of program instructions. Using a dataflow execution approach, the execution order of program instructions by an OOP may be determined by the availability of input data for each program instruction (i.e., “dataflow order”), rather than the program order of the program instructions. Thus, the OOP may execute a program instruction as soon as all input data for the program instruction has been generated. While the specific order in which program instructions are executed may be unpredictable, the OOP may realize performance gains using dataflow execution of the program instructions. For example, instead of having to “stall” (i.e., intentionally introduce a processing delay) while input data is retrieved for an older program instruction, the OOP may proceed with executing a more recently fetched program instruction that is capable of immediate execution. In this manner, processor clock cycles that would otherwise be wasted may be productively utilized by the OOP.

In the case of program loops, an OOP may effectively enable dynamic software pipelining of a loop by executing loop instructions in a dataflow manner. Dataflow execution of loop instructions by the OOP may be facilitated through the use of an OOP microarchitecture feature known as a “reservation station segment.” A reservation station segment stores a loop instruction along with related information required for execution, such as operands. The OOP loads each loop instruction associated with a loop into a corresponding reservation station segment. Each reservation station segment is configured to hold a loop instruction for a specified number of loop iterations, rather than retiring the loop instruction before the loop has completed executing. During an iteration of the loop, when a reservation station segment determines that all input data for its resident loop instruction is available, the reservation station segment provides the loop instruction and its input data to a functional unit of the OOP for execution. The reservation station segment then maintains its resident loop instruction and awaits input data for a next loop iteration. Only after the loop has completed all iterations are the loop instructions associated with the loop retired from the reservation station segment. By maintaining loop instructions in reservation station segments during iterations of the loop, the OOP avoids the need to repeatedly fetch and decode the loop instructions, resulting in improved processor performance and reduced power consumption.

However, an issue that arises with reservation station segments used to execute loop instructions is the enforcement of loop-carried dependency (LCD), also referred to as inter-iteration data dependency. An LCD occurs when the data produced by a loop instruction in iteration i of a loop is consumed by another loop instruction in iteration j of the loop, where i<j. For example, a loop instruction A that executes in loop iteration j may require, as input, an execution result generated by a loop instruction B in iteration i, where i=j−2 (e.g., A[j]=B[j−2]). Because of the out-of-order nature of dataflow execution of the loop instructions by an OOP, instructions belonging to different iterations of the loop may execute concurrently. Thus, a mechanism for ensuring the proper handling of LCD occurrences is desirable.

### SUMMARY OF THE DISCLOSURE

Aspects disclosed in the detailed description include enforcing loop-carried dependency (LCD) during dataflow execution of loop instructions by out-of-order processors (OOPs). Related circuits, methods, and computer-readable media are also disclosed. In this regard, in one aspect, a reservation station circuit for enforcing LCD during dataflow execution of loop instructions is provided. The reservation station circuit includes one or more reservation station segments, each of which is configured to store a “consumer loop instruction” (i.e., a loop instruction that requires operand data generated by one or more other loop instructions as input). Each reservation station segment also includes an operand buffer for each operand of the consumer loop instruction. Each operand buffer may be used to track the identity of a corresponding “producer loop instruction” (i.e., a loop instruction that generates operand data), and may contain multiple operand buffer entries for storing operand data produced in different loop iterations. Each operand buffer also includes an LCD offset indicator, which is indicative of an “LCD distance” between the producer loop instruction and the consumer loop instruction. As used herein, an “LCD distance” refers to a number of loop iterations between: the loop iteration in which the producer loop instruction generates operand data, and the loop iteration in which the consumer loop instruction utilizes the operand data. For example, an LCD distance of zero (0) between the consumer loop instruction and the producer loop instruction would indicate that the consumer loop instruction requires an operand generated by the producer loop instruction within the same loop iteration. If the consumer loop instruction requires an operand generated two loop iterations prior by the producer loop instruction, the LCD distance between the loop instructions would be two (2).

After a producer loop instruction executes, each reservation station segment receives an execution result of the producer loop instruction, along with a loop iteration indicator that indicates a current loop iteration for the producer loop instruction. The reservation station segment generates an operand buffer index based on the loop iteration indicator of the producer loop instruction and the LCD offset indicator of the operand buffer corresponding to the execution result. The reservation station segment then stores the execution result in the operand buffer at an operand buffer entry indicated by the operand buffer index. By evaluating the loop iteration indicator and the LCD offset indicator at the time of storage, the reservation station segment ensures that the execution result is available in the operand buffer at an appropriate location for consumption by the consumer loop instruction in a future loop iteration. In this manner, the reservation station segment enforces LCD during execution of the loop.

In another aspect, a reservation station circuit for enforcing LCD during dataflow execution of loop instructions is provided. The reservation station circuit includes one or more reservation station segments. Each reservation station segment comprises a loop instruction register configured to store a consumer loop instruction of a loop, and also comprises one or more operand buffers. Each operand buffer corresponds to an operand of the consumer loop instruction, and includes a producer identifier indicator indicative of a producer loop instruction of the operand. Each operand buffer also comprises an LCD offset indicator indicative of an LCD distance between the producer loop instruction and the consumer loop instruction. Each operand buffer further comprises one or more operand buffer entries. Each reservation station segment of the one or more reservation station segments is configured to receive a producer identifier corresponding to a value of the producer identifier indicator of an operand buffer of the one or more operand buffers of the one or more reservation station segments, and indicative of the producer loop instruction. Each reservation station segment is also configured to receive an execution result of the producer loop instruction, and receive a loop iteration indicator indicative of a current loop iteration for the producer loop instruction. Each reservation station segment is also configured to generate an operand buffer index based on the loop iteration indicator and the LCD offset indicator of the operand buffer. Each reservation station segment is additionally configured to store the execution result as a first operand buffer entry of the one or more operand buffer entries of the operand buffer, the first operand buffer entry indicated by the operand buffer index.

In another aspect, a reservation station circuit for enforcing LCD in dataflow execution of loop instructions is provided. The reservation station circuit comprises a means for receiving, by a reservation station segment of one or more reservation station segments, a producer identifier corresponding to an operand buffer of one or more operand buffers of the reservation station segment, and indicative of a producer loop instruction. The reservation station circuit also comprises a means for receiving, by the reservation station segment, an execution result of the producer loop instruction. The reservation station circuit additionally comprises a means for receiving, by the reservation station segment, a loop iteration indicator indicative of a current loop iteration for the producer loop instruction. The reservation station circuit further comprises a means for generating an operand buffer index based on the loop iteration indicator and an LCD offset indicator corresponding to the operand buffer, the LCD offset indicator indicative of an LCD distance between the producer loop instruction and a consumer loop instruction of the reservation station segment. The reservation station circuit also comprises a means for storing the execution result as a first operand buffer entry of the operand buffer, the first operand buffer entry indicated by the operand buffer index.

In another aspect, a method for enforcing LCD during dataflow execution of loop instructions is provided. The method comprises receiving, by a reservation station segment of one or more reservation station segments, a producer identifier corresponding to an operand buffer of one or more operand buffers of the reservation station segment, and indicative of a producer loop instruction. The method further comprises receiving, by the reservation station segment, an execution result of the producer loop instruction. The method also comprises receiving, by the reservation station segment, a loop iteration indicator indicative of a current loop iteration for the producer loop instruction. The method additionally comprises generating an operand buffer index based on the loop iteration indicator and an LCD offset indicator corresponding to the operand buffer, the LCD offset indicator indicative of an LCD distance between the producer loop instruction and a consumer loop instruction of the reservation station segment. The method further comprises storing the execution result as a first operand buffer entry of the operand buffer, the first operand buffer entry indicated by the operand buffer index.

In another aspect, a non-transitory computer-readable medium having stored thereon computer-executable instructions to cause a processor to implement a method for enforcing LCD during dataflow execution of loop instructions is provided. The method implemented by the computer-executable instructions comprises receiving, by a reservation station segment of one or more reservation station segments, a producer identifier corresponding to an operand buffer of one or more operand buffers of the reservation station segment, and indicative of a producer loop instruction. The method implemented by the computer-executable instructions further comprises receiving, by the reservation station segment, an execution result of the producer loop instruction. The method implemented by the computer-executable instructions also comprises receiving, by the reservation station segment, a loop iteration indicator indicative of a current loop iteration for the producer loop instruction. The method implemented by the computer-executable instructions additionally comprises generating an operand buffer index based on the loop iteration indicator and an LCD offset indicator corresponding to the operand buffer, the LCD offset indicator indicative of an LCD distance between the producer loop instruction and a consumer loop instruction of the reservation station segment. The method implemented by the computer-executable instructions further comprises storing the execution result as a first operand buffer entry of the operand buffer, the first operand buffer entry indicated by the operand buffer index.

### BRIEF DESCRIPTION OF THE FIGURES

FIG. 1 is a block diagram illustrating an exemplary out-of-order processor (OOP) that includes a reservation station circuit enforcing loop-carried dependency (LCD) during dataflow execution of loop instructions;

FIG. 2 is a diagram illustrating an exemplary reservation station segment;

FIG. 3 is a diagram illustrating results of dataflow execution of a producer loop instruction, and subsequent broadcast and storage of the execution result by the reservation station circuit of FIG. 1 to enforce LCD;

FIG. 4 is diagram illustrating results of dataflow execution of a consumer loop instruction of FIG. 3, and the subsequent broadcast of the execution result;

FIG. 5 is a flowchart illustrating exemplary operations for enforcing LCD by the reservation station circuit of FIG. 1 during dataflow execution of loop instructions;

FIG. 6 is a flowchart illustrating additional exemplary operations for broadcasting an execution result of a consumer loop instruction to other reservation station segments in the exemplary OOP of FIG. 1; and

FIG. 7 is a block diagram of an exemplary processor-based system that can include the reservation station circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include enforcing loop-carried dependency (LCD) during dataflow execution of loop instructions by out-of-order processors (OOPs). Related circuits, methods, and computer-readable media are also disclosed. In this regard, in one aspect, a reservation station circuit for enforcing LCD during dataflow execution of loop instructions is provided. The reservation station circuit includes one or more reservation station segments, each of which is configured to store a “consumer loop instruction” (i.e., a loop instruction that requires operand data generated by one or more other loop instructions as input). Each reservation station segment also includes an operand buffer for each operand of the consumer loop instruction. Each operand buffer may be used to track the identity of a corresponding “producer loop instruction” (i.e., a loop instruction that generates operand data), and may contain multiple operand buffer entries for storing operand data produced in different loop iterations. Each operand buffer also includes an LCD offset indicator, which is indicative of an “LCD distance” between the producer loop instruction and the consumer loop instruction. As used herein, an “LCD distance” refers to a number of loop iterations between: the loop iteration in which the producer loop instruction generates operand data, and the loop iteration in which the consumer loop instruction utilizes the operand data. For example, an LCD distance of zero (0) between the consumer loop instruction and the producer loop instruction would indicate that the consumer loop instruction requires an operand generated by the producer loop instruction within the same loop iteration. If the consumer loop instruction requires an operand generated two loop iterations prior by the producer loop instruction, the LCD distance between the loop instructions would be two (2).

After a producer loop instruction executes, each reservation station segment receives an execution result of the producer loop instruction, along with a loop iteration indicator that indicates a current loop iteration for the producer loop instruction. The reservation station segment generates an operand buffer index based on the loop iteration indicator of the producer loop instruction and the LCD offset indicator of the operand buffer corresponding to the execution result. The reservation station segment then stores the execution result in the operand buffer at an operand buffer entry indicated by the operand buffer index. By evaluating the loop iteration indicator and the LCD offset indicator at the time of storage, the reservation station segment ensures that the execution result is available in the operand buffer at an appropriate location for consumption by the consumer loop instruction in a future loop iteration. In this manner, the reservation station segment enforces LCD during execution of the loop.

In another aspect, a reservation station circuit for enforcing LCD during dataflow execution of loop instructions is provided. The reservation station circuit includes one or more reservation station segments. Each reservation station segment comprises a loop instruction register configured to store a consumer loop instruction of a loop, and also comprises one or more operand buffers. Each operand buffer corresponds to an operand of the consumer loop instruction, and includes a producer identifier indicator indicative of a producer loop instruction of the operand. Each operand buffer also comprises an LCD offset indicator indicative of an LCD distance between the producer loop instruction and the consumer loop instruction. Each operand buffer further comprises one or more operand buffer entries. Each reservation station segment of the one or more reservation station segments is configured to receive a producer identifier corresponding to a value of the producer identifier indicator of an operand buffer of the one or more operand buffers of the one or more reservation station segments, and indicative of the producer loop instruction. Each reservation station segment is also configured to receive an execution result of the producer loop instruction, and receive a loop iteration indicator indicative of a current loop iteration for the producer loop instruction. Each reservation station segment is also configured to generate an operand buffer index based on the loop iteration indicator and the LCD offset indicator of the operand buffer. Each reservation station segment is additionally configured to store the execution result as a first operand buffer entry of the one or more operand buffer entries of the operand buffer, the first operand buffer entry indicated by the operand buffer index.

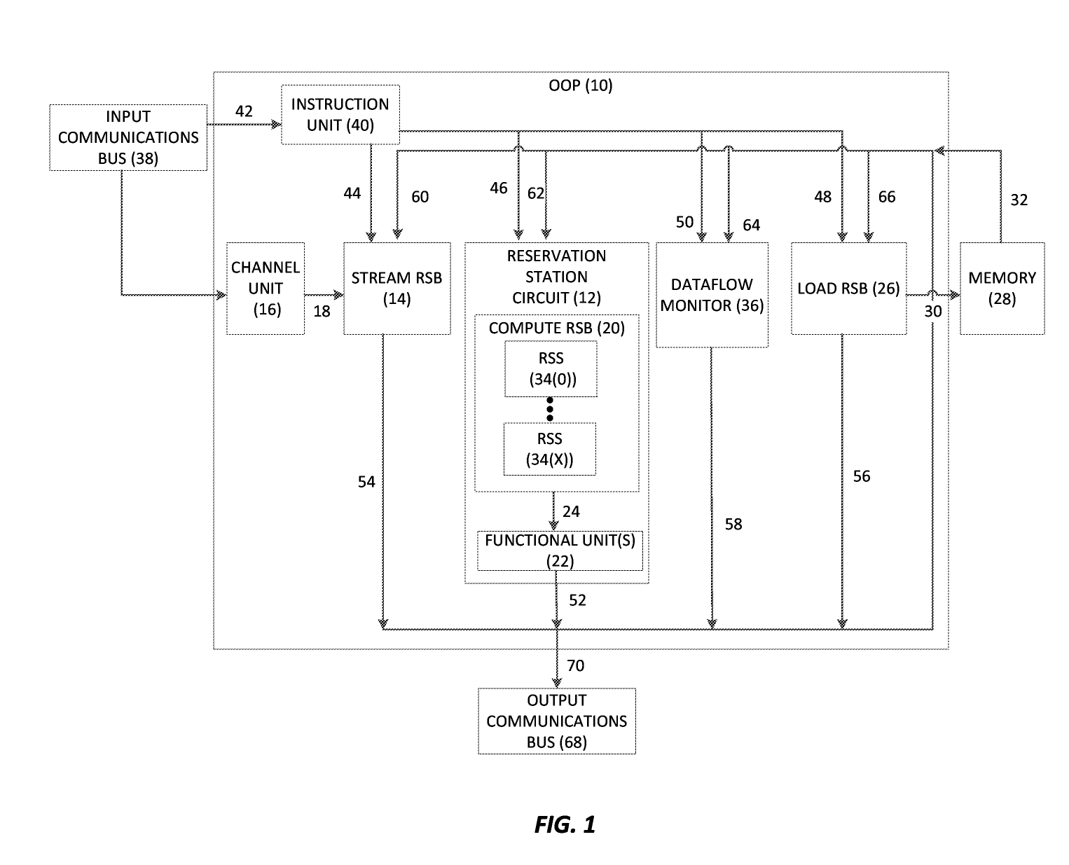

In this regard, FIG. 1 is a block diagram of an OOP 10 configured to provide enforcement of LCD during dataflow execution of loop instructions. In particular, the OOP 10 includes a reservation station circuit 12 for maintaining an LCD offset indicator (not shown) for each operand of a consumer loop instruction, and for evaluating the LCD offset indicator when storing an execution result from a producer loop instruction. The OOP 10 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. While FIG. 1 illustrates a single OOP 10, it is to be understood that some aspects may provide multiple, communicatively coupled OOPs 10. It is to be further understood that, as used herein, the terms “producer loop instruction” and “consumer loop instruction” are used in the context of a relationship between two given loop instructions, where the first loop instruction generates an execution result that serves as input to the second loop instruction. Thus, a loop instruction that is a “consumer loop instruction” in one context (e.g., the loop instruction receives input data from another loop instruction) may also be a “producer loop instruction” in another context (e.g., the loop instruction then generates data for use by yet another loop instruction).

In some environments, an application program may be conceptualized as a “pipeline” of kernels (i.e., specific areas of functionality), wherein each kernel operates on a stream of data tokens passing through the pipeline. The OOP 10 of FIG. 1 may embody a programmable core for implementing the functionality of a single kernel, and for repeatedly applying that functionality to different sets of data streamed to the OOP 10. To provide kernel functionality in an energy efficient manner, the OOP 10 may provide a feature referred to herein as “instruction re-vitalization.” Instruction re-vitalization enables a set of program instructions to be loaded together into the OOP 10, and to be subsequently executed multiple times without being retired or evicted from the OOP 10. In this manner, the OOP 10 may iteratively execute the set of instructions on successive data items streamed into the OOP 10. Instruction re-vitalization may thus reduce energy consumption and improve processor performance of the OOP 10 by eliminating the need for a multi-stage execution pipeline. Due to the iterative nature of programming constructs such as loops, instruction re-vitalization may make the OOP 10 especially suited for processing kernels comprising loop instructions.

The OOP 10 is organized into one or more reservation station blocks (also referred to herein as “RSBs”), each of which may correspond to a general type of program instruction. For example, a stream RSB 14 may handle instructions for receiving data streams via a channel unit 16, as indicated by arrow 18. A compute RSB 20 may handle instructions that access one or more functional units 22 (e.g., an arithmetic logic unit (ALU) and/or a floating point unit) for carrying out computational operations, as indicated by arrow 24. An execution result produced by instructions in the compute RSB 20 may be consumed as input by other instructions in the compute RSB 20. A load RSB 26 handles instructions for loading data from and outputting data to a data store, such as a memory 28, as indicated by arrows 30 and 32. It is to be understood that there may be more than one of each of the stream RSB 14, the compute RSB 20, and/or the load RSB 26.

In the example of FIG. 1, the compute RSB 20 includes one or more reservation station segments (also referred to herein as “RSSs”) 34(0)-34(X), each of which stores a single loop instruction along with associated operand data required for dataflow execution of the loop instruction. It is to be understood that, although not illustrated in FIG. 1, the stream RSB 14 and/or the load RSB 26 may each also include one or more reservation station segments that operate in a manner corresponding to the operation of the reservation station segments 34. For the sake of clarity, the reservation station segments of the stream RSB 14 and the load RSB 26 are omitted from FIG. 1.

The OOP 10 of FIG. 1 also includes a dataflow monitor 36, which tracks the flow of data through the OOP 10 during dataflow execution of loop instructions. In some aspects, the dataflow monitor 36 may provide functionality for sending commands to control the production and/or consumption of operands by loop instructions. The dataflow monitor 36 may also be configured to track loop iterations, and to carry out operations upon completion of each loop iteration and/or upon completion of a loop.

In typical operation, an input communications bus 38 communicates instructions for the kernel to be executed by the OOP 10 to an instruction unit 40 of the OOP 10, as indicated by arrow 42. The instruction unit 40 then loads the instructions into the one or more reservation station segments (not shown) of the stream RSB 14 (as indicated by arrow 44), the one or more reservation station segments 34(0)-34(X) of the compute RSB 20 (as indicated by arrow 46), and/or the one or more reservation station segments (not shown) of the load RSB 26 (as indicated by arrow 48), based on the instruction type. The dataflow monitor 36 may also receive initialization data, such as a number of loop iterations to execute, as indicated by arrow 50.

The OOP 10 may then execute the resident instructions of the reservation station segments 34(0)-34(X) of the compute RSB 20 in any appropriate order. As a non-limiting example, the OOP 10 may execute the resident instructions of the reservation station segments 34(0)-34(X) in a dataflow execution order. The execution results (if any) produced by execution of each resident instruction and an identifier for the resident instruction are broadcast by the reservation station segments 34(0)-34(X), as indicated by arrow 52. Similarly, the stream RSB 14 and/or the load RSB 26 broadcast the execution results (if any) produced by resident instructions of their respective reservation station segments (not shown), as indicated by arrows 54 and 56. The dataflow monitor 36 may also broadcast data to the RSBs 14, 20, and 26, as indicated by arrow 58. The stream RSB 14, the compute RSB 20, the dataflow monitor 36, and the load RSB 26 then receive the broadcast data as input streams 60, 62, 64, and 66, respectively.

In the example of FIG. 1, the reservation station segments 34(0)-34(X) of the compute RSB 20 monitor the input stream 62 to identify execution results from previously executed instructions that are required as input operands. Once detected, the input operands may be stored, and after all required operands are received, the resident instruction associated with each reservation station segment 34(0)-34(X) may be provided for dataflow execution. Loop instructions for a loop may thus be iteratively executed in a dataflow manner until the dataflow monitor 36 detects that all iterations of the loop have completed. Data may be streamed out of the OOP 10 to an output communications bus 68, as indicated by arrow 70.

One issue that may arise with the OOP 10 of FIG. 1 is the enforcement of LCD between the resident instructions of the reservation station segments 34. As discussed above, an LCD occurs when the data produced by a loop instruction in iteration i of a loop is consumed by another loop instruction in iteration j of the loop, where i<j. For instance, consider the loop instruction A[j]=B[j−2]+1. In this example, the loop instruction A, which executes in iteration j of a loop, requires, as input, an execution result generated by the loop instruction B in iteration j−2 (i.e., two loop iterations before execution of the loop instruction A). Thus, an LCD exists between the loop instruction A and the loop instruction B. However, because of the out-of-order nature of dataflow execution of the loop instructions by the OOP 10, the reservation station segments 34 corresponding to instructions A and B may operate within different loop iterations.

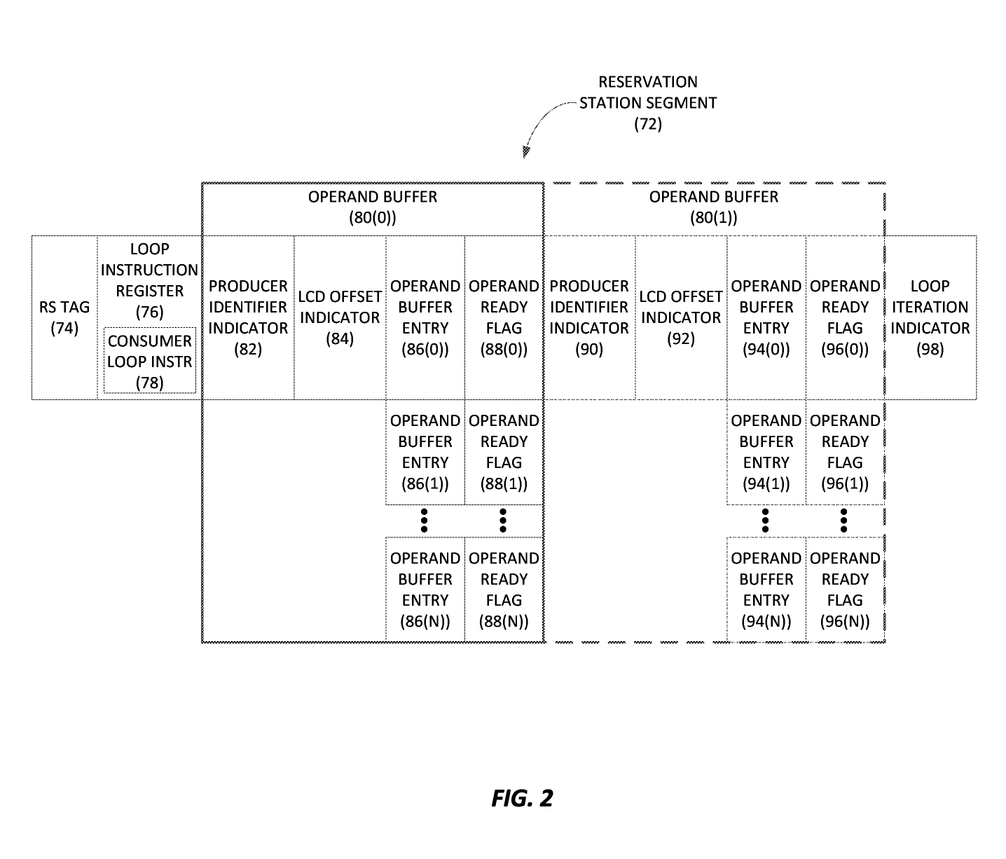

In this regard, the reservation station circuit 12 of FIG. 1 is provided. As discussed in greater detail with respect to FIGS. 2-4, each of the reservation station segments 34 of the reservation station circuit 12 provides operand buffers to store multiple copies of operand data for consumption by the resident loop instruction. Each operand buffer entry within the operand buffers corresponds to a loop iteration in which the loop instruction will execute. For example, in some aspects, an operand buffer entry having an index of zero (0) may hold operand data to be executed in a loop iteration zero (0), an operand buffer entry having an index of one (1) may store operand data for loop iteration one (1), and so on. At the time operand data is received by a reservation station segment 34 of the reservation station circuit 12, the reservation station segment 34 is aware of the loop iteration in which the producer loop instruction executed, as well as the LCD distance between the producer loop instruction and the consumer loop instruction of the reservation station segment 34. Based on the loop iteration of the producer loop instruction and the LCD distance, the reservation station segment 34 can determine a location within an operand buffer that corresponds to a future iteration of the consumer loop instruction of the reservation station segment 34, and may store the operand data accordingly.

To illustrate in greater detail elements of an exemplary reservation station segment 72, such as one of the reservation station segments 34(0)-34(X) of FIG. 1, FIG. 2 is provided. It is to be understood that the elements shown in FIG. 2 are for illustrative purposes only, and that some aspects of the reservation station segments 34 of FIG. 1 may include more or fewer elements than shown in FIG. 2. FIG. 2 shows the reservation station segment 72, which includes a reservation station (RS) tag 74 that serves as a unique identifier for the reservation station segment 72. The reservation station segment 72 also includes a loop instruction register 76, which stores a consumer loop instruction 78 within the reservation station segment 72. As a non-limiting example, the consumer loop instruction 78 may be an instruction opcode. In some aspects, the RS tag 74 may include an end flag (not shown) indicating whether or not the consumer loop instruction 78 is a “leaf” instruction in a dataflow ordering of instructions (i.e., an instruction on which there are no output data dependencies). The dataflow monitor 36 of FIG. 1 may use the end flag to detect when a loop iteration has completed.

The reservation station segment 72 of FIG. 2 also provides storage for operand data that is required by the consumer loop instruction 78 for execution. In the example of FIG. 2, the reservation station segment 72 provides operand buffers 80(0) and 80(1) to store operand data for a first operand and a second operand (not shown) associated with the consumer loop instruction 78. The operand buffer 80(0) includes a producer identifier indicator 82 that is indicative of a reservation station segment (not shown) of a producer loop instruction (not shown) that generates the first operand. The operand buffer 80(0) further includes an LCD offset indicator 84, which represents the LCD distance between the producer loop instruction and the consumer loop instruction 78. In some aspects, the LCD offset indicator 84 may comprise an integer value.

The operand buffer 80(0) also includes one or more operand buffer entries 86(0)-86(N), and a corresponding one or more operand ready flags 88(0)-88(N). Each of the operand buffer entries 86(0)-86(N) may store an operand value generated by a producer loop instruction during a corresponding loop iteration, while each operand ready flag 88(0)-88(N) may indicate when the associated operand buffer entry 86(0)-86(N) is ready for consumption by the consumer loop instruction 78. Accordingly, the operand buffer 80(0) may maintain values in up to ‘N’ operand buffer entries 86 at a given time. Each operand buffer entry 86 may be consumed by the consumer loop instruction 78 during a loop iteration. For example, the operand buffer entry 86(0) may be consumed during a loop iteration zero (0), an operand buffer entry 86(1) may be consumed during loop iteration one (1), and so on. If a loop iteration ‘L’ is greater than ‘N,’ the reservation station segment 72 may use a mapping function (such as L mod N) to determine which of the operand buffer entries 86(0)-86(N) corresponds to a given loop iteration.

Similarly, to store data associated with the second operand, the reservation station segment 72 provides an operand buffer 80(1), which includes a producer identifier indicator 90, an LCD offset indicator 92, one or more operand buffer entries 94(0)-94(N), and a corresponding one or more operand ready flags 96(0)-96(N). The producer identifier indicator 90, the LCD offset indicator 92, the operand buffer entries 94(0)-94(N), and the operand ready flags 96(0)-96(N) of the operand buffer 80(1) may function in a manner corresponding to the functionality of the producer identifier indicator 82, the LCD offset indicator 84, the operand buffer entries 86(0)-86(N), and the operand ready flags 88(0)-88(N) of the operand buffer 80(0), respectively.

The reservation station segment 72 also includes a loop iteration indicator 98. The loop iteration indicator 98 may be set to an initial value of zero (0), and subsequently incremented with each execution of the consumer loop instruction 78. A current value of the loop iteration indicator 98 may be provided by the reservation station segment 72 when the consumer loop instruction 78 is provided for dataflow execution, and may be broadcast to other reservation station segments along with an execution result of the consumer loop instruction 78. In this manner, the current value of the loop iteration indicator 98 may be used by subsequently-executing consumer loop instructions to determine the loop iteration in which the consumer loop instruction 78 executed.

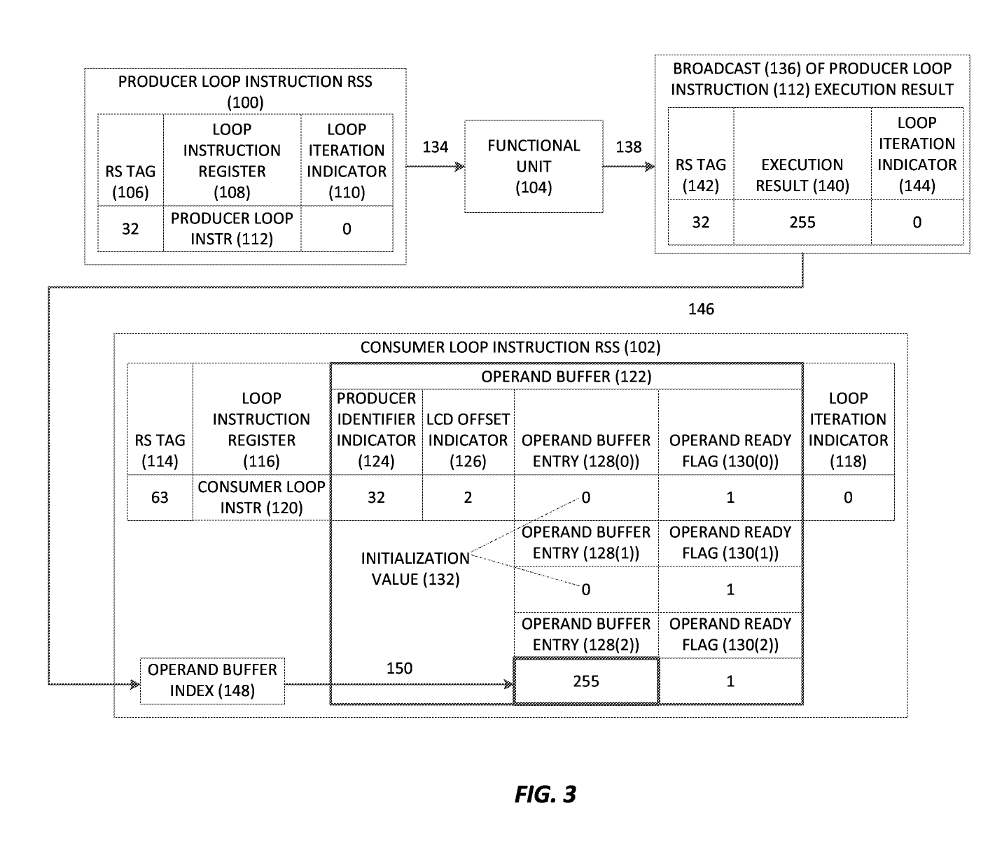

FIG. 3 is a diagram illustrating results of dataflow execution of a producer loop instruction by a functional unit of the OOP 10, and subsequent broadcast and storage of the execution result by the reservation station circuit 12 of FIG. 1 to enforce LCD. In FIG. 3, a producer loop instruction RSS 100 and a consumer loop instruction RSS 102 are provided, each having functionality corresponding to the functionality of the reservation station segments 34 of FIG. 1. A functional unit 104 represents a functional unit (such as an ALU or floating point unit, as non-limiting examples) that corresponds to the one or more functional units 22 of FIG. 1.

In this example, the producer loop instruction RSS 100 includes an RS tag 106, a loop instruction register 108, and a loop iteration indicator 110. The RS tag 106 is assigned a value of 32, which represents a unique identifier for the producer loop instruction RSS 100. The loop instruction register 108 of the producer loop instruction RSS 100 contains a producer loop instruction 112 which will be executed in a dataflow manner, while the loop iteration indicator 110 indicates that the producer loop instruction RSS 100 is operating within loop iteration 0. For the sake of clarity, the producer loop instruction RSS 100 is shown without operand buffers. However, it is to be understood that the producer loop instruction RSS 100 may include one or more operand buffers, such as the operand buffers 80 of FIG. 2.

Like the producer loop instruction RSS 100, the consumer loop instruction RSS 102 also includes an RS tag 114, a loop instruction register 116, and a loop iteration indicator 118. The RS tag 114 has a value of 63, representing a unique identifier for the consumer loop instruction RSS 102. The loop instruction register 116 contains a consumer loop instruction 120, which will be executed in a dataflow manner using input data generated by the producer loop instruction 112. The loop iteration indicator 118 of the consumer loop instruction RSS 102 indicates that the consumer loop instruction RSS 102 is operating within loop iteration 0.

The consumer loop instruction RSS 102 also includes an operand buffer 122, corresponding to an operand (not shown) required by the consumer loop instruction 120 to execute. The operand buffer 122 includes a producer identifier indicator 124, which represents an identifier of a producer loop instruction that generates the required operand. In this example, the producer identifier indicator 124 has a value of 32, indicating that the producer loop instruction 112 of the producer loop instruction RSS 100 generates the operand. The operand buffer 122 further includes an LCD offset indicator 126 representing the LCD distance between the producer loop instruction 112 and the consumer loop instruction 120. In FIG. 3, the LCD offset indicator 126 of the operand buffer 122 has a value of 2, which indicates that the operand required by the consumer loop instruction 120 during a given loop iteration is generated two loop iterations earlier by the producer loop instruction 112.

The operand buffer 122 additionally includes three operand buffer entries 128(0)-128(2) and corresponding operand ready flags 130(0)-130(2). In some aspects where the value of the LCD offset indicator 126 is greater than zero, one or more the operand buffer entries 128 having an index less than the LCD offset indicator 126 may have an initialization value 132 set prior to loop execution. For instance, in FIG. 3, the operand buffer entries 128(0) and 128(1) are both initialized with a value of zero (0). This may ensure that the operand buffer entries 128(0) and 128(1) contain valid data for execution of the consumer loop instruction 120. Upon initialization of the operand buffer entries 128(0) and 128(1), the operand ready flags 130(0) and 130(1) may also be set to indicate that the operand buffer entries 128(0) and 128(1) are ready for consumption by the consumer loop instruction 120.

During the execution of the loop by the OOP 10, the producer loop instruction RSS 100 provides the producer loop instruction 112 to the functional unit 104 for execution, as indicated by arrow 134. When execution of the producer loop instruction 112 is complete, the functional unit 104 outputs a broadcast 136 to all reservation station segments of the OOP 10, as indicated by arrow 138. The broadcast 136 includes an execution result 140 generated by the producer loop instruction 112 (in this example, an integer value 255). The broadcast 136 also includes an RS tag 142 having a value of 32, which identifies the producer loop instruction RSS 100 as the source of the execution result 140. The broadcast 136 further provides a loop iteration indicator 144 having a value corresponding to the loop iteration indicator 110 of the producer loop instruction RSS 100. In the example of FIG. 3, the loop iteration indicator 144 indicates that the execution result 140 was generated by the producer loop instruction 112 during loop iteration 0.

The broadcast 136 is then received by the consumer loop instruction RSS 102, as indicated by arrow 146. Upon receiving the broadcast 136, the consumer loop instruction RSS 102 compares the RS tag 142 of the broadcast 136 with the producer identifier indicator 124 of the operand buffer 122. A match indicates that the execution result 140 of the broadcast 136 corresponds to an operand of the consumer loop instruction 120 of the consumer loop instruction RSS 102. In this example, both the RS tag 142 and the producer identifier indicator 124 have a value of 32, representing a match.

The consumer loop instruction RSS 102 next determines an appropriate location within the operand buffer 122 to store the execution result 140. This is accomplished by generating an operand buffer index 148 based on the loop iteration indicator 144 of the broadcast 136 and the LCD offset indicator 126 of the operand buffer 122. In the aspect illustrated in FIG. 3, the operand buffer index 148 is generated by summing a value of the loop iteration indicator 144 (i.e., 0) and a value of the LCD offset indicator 126 of the operand buffer 122 (i.e., 2). This results in an operand buffer index 148 value of 2. Using the operand buffer index 148 as an index into the operand buffer 122, the execution result 140 is then stored in the operand buffer entry 128(2), as indicated by arrow 150. Because each operand buffer entry 128 is associated with a loop iteration of the consumer loop instruction 120, the consumer loop instruction RSS 102 may use the operand buffer index 148 in this manner to store the execution result 140 for consumption by the consumer loop instruction 120 in a future loop iteration.

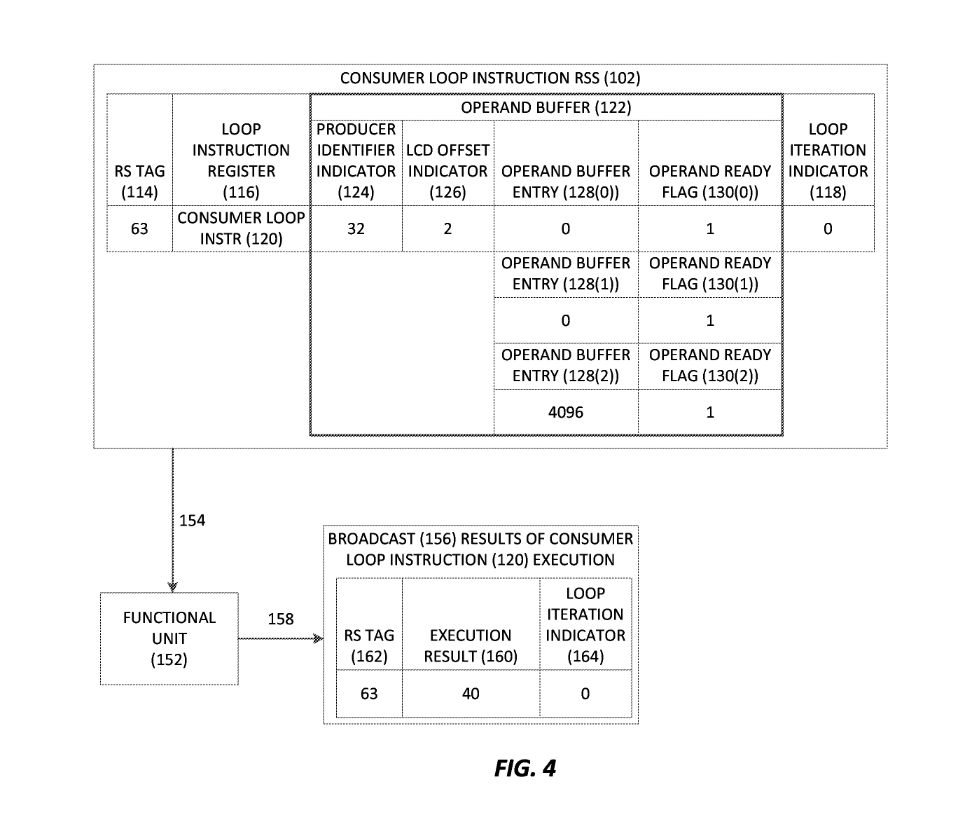

After storing the execution result 140 in the operand buffer entry 128(2), the consumer loop instruction RSS 102 may provide the consumer loop instruction 120 for execution in much the same way that the producer loop instruction RSS 100 provided the producer loop instruction 112 for execution. In this regard, FIG. 4 is provided to illustrate the execution of the consumer loop instruction 120 and the broadcast of the execution result 140. In FIG. 4, the consumer loop instruction RSS 102 of FIG. 3 is shown immediately following the storage of the execution result 140 generated by the producer loop instruction 112 in the operand buffer entry 128(2). As loop execution continues by the OOP 10, the consumer loop instruction RSS 102 provides the consumer loop instruction 120 to a functional unit 152 for execution, as indicated by arrow 154. Like the functional unit 104 of FIG. 3, the functional unit 152 of FIG. 4 represents a functional unit (such as an ALU or floating point unit, as non-limiting examples) that corresponds to the one or more functional units 22 of FIG. 1.

When execution of the consumer loop instruction 120 is complete, the functional unit 152 outputs a broadcast 156 to all reservation station segments of the OOP 10, as indicated by arrow 158. The broadcast 156 includes an execution result 160 generated by the consumer loop instruction 120 (in this example, an integer value of 40). The broadcast 156 also includes an RS tag 162 having a value of 63, which identifies the consumer loop instruction RSS 102 as the source of the execution result 160. The broadcast 156 further provides a loop iteration indicator 164 having a value corresponding to the loop iteration indicator 118 of the consumer loop instruction RSS 102. In the example of FIG. 4, the loop iteration indicator 164 indicates that the execution result 160 was generated by the consumer loop instruction 120 during loop iteration 0. By broadcasting its execution result 160 to other reservation station segments, the consumer loop instruction 120 may act as a producer loop instruction to other loop instructions of the loop.

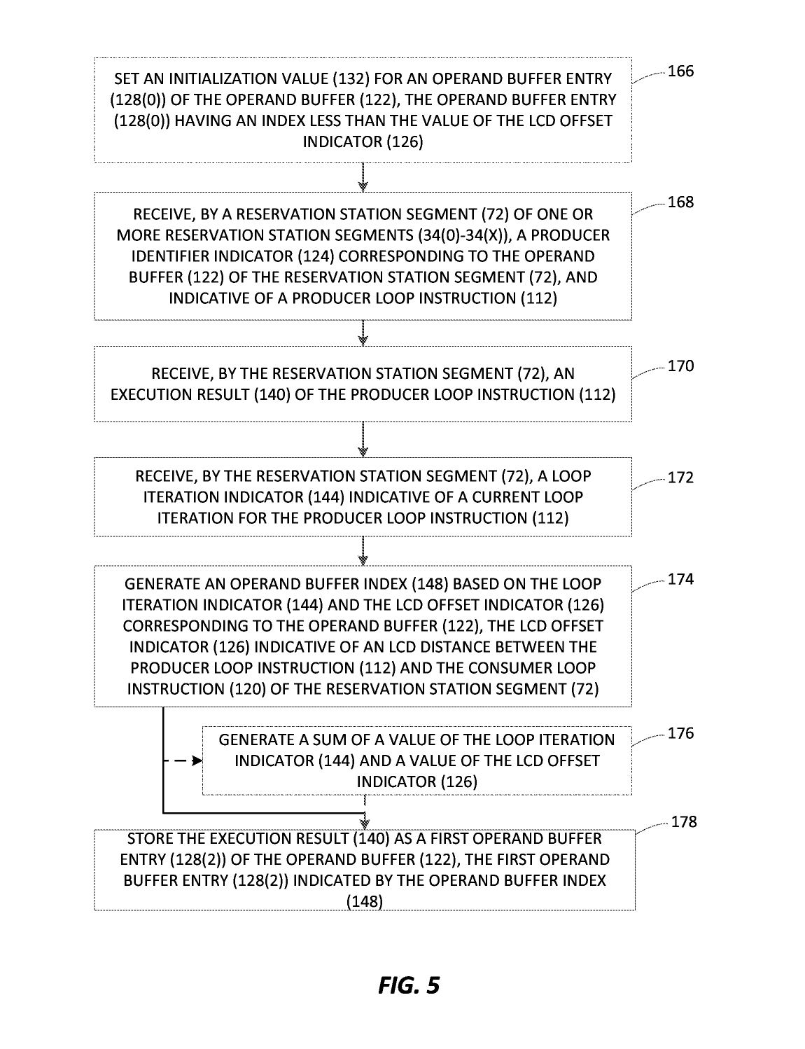

To illustrate exemplary operations for enforcing LCD by the reservation station circuit 12 of FIG. 1 during dataflow execution of loop instructions, FIG. 5 is provided. For the sake of clarity, elements of FIGS. 1-3 are referenced in describing FIG. 5. In FIG. 5, operations begin with the reservation station circuit 12 optionally setting an initialization value 132 for an operand buffer entry 128(0) of the operand buffer 122, the operand buffer entry 128(0) having an index less than the value of the LCD offset indicator 126 (block 166). By doing so, the reservation station circuit 12 may ensure that valid data is present in the operand buffer entry 128(0) for execution of the consumer loop instruction 120.

The reservation station segment 72 (e.g., one of the one or more reservation station segments 34(0)-34(X) of the reservation station circuit 12 next receives a producer identifier indicator 124 corresponding to the operand buffer 122 of the reservation station segment 72, and indicative of a producer loop instruction 112 (block 168). The reservation station segment 72 also receives an execution result 140 of the producer loop instruction 112 (block 170). The reservation station segment 72 further receives a loop iteration indicator 144 indicative of a current loop iteration for the producer loop instruction 112 (block 172). In some aspects, the loop iteration indicator 144 may comprise an integer value.

The reservation station segment 72 of the reservation station circuit 12 then generates an operand buffer index 148 based on the loop iteration indicator 144 and the LCD offset indicator 126 corresponding to the operand buffer 122 (block 174). The LCD offset indicator 126 is indicative of an LCD distance between the producer loop instruction 112 and the consumer loop instruction 120 of the reservation station segment 72 (block 174). According to some aspects disclosed herein, the operand buffer index 148 may be generated by generating a sum of a value of the loop iteration indicator 144 and a value of the LCD offset indicator 126 (block 176). The execution result 140 is then stored by the reservation station segment 72 as an operand buffer entry 128(2) of the operand buffer 122, the operand buffer entry 128(2) indicated by the operand buffer index 148 (block 178). Some aspects may provide that the operand buffer index 148 may be used as an index indicating in which operand buffer entry 128 the execution result 140 is stored.

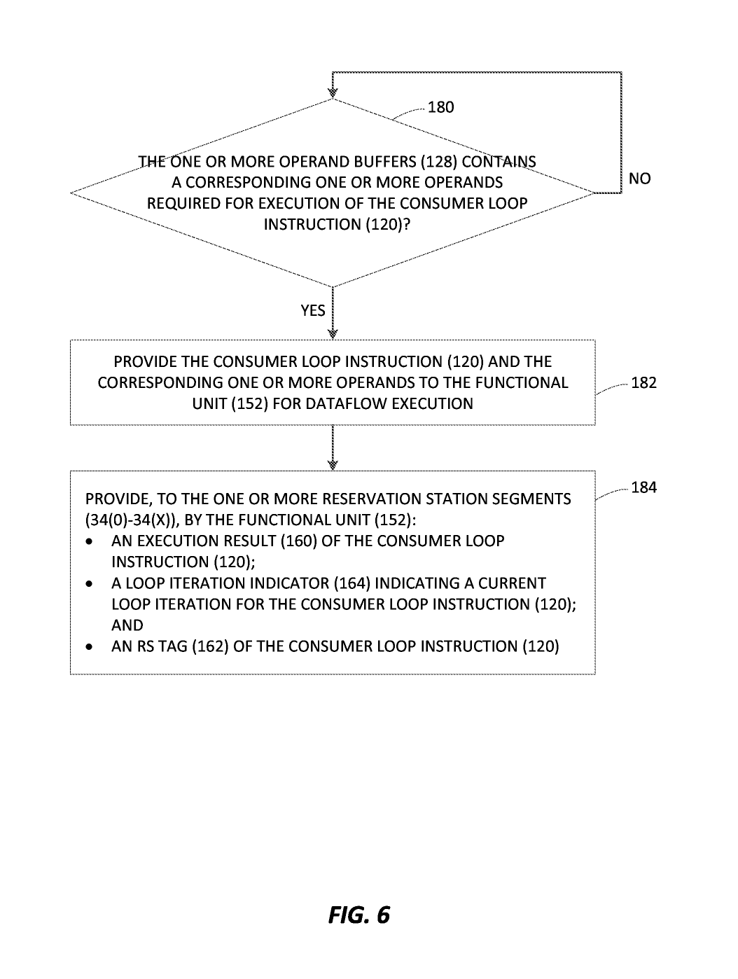

FIG. 6 is a flowchart illustrating additional exemplary operations for broadcasting an execution result to other reservation station segments in the exemplary OOP 10 of FIG. 1. In describing FIG. 6, elements of FIGS. 1-4 are referenced for the sake of clarity. Operations in FIG. 6 begin with the reservation station segment 72 of the reservation station circuit 12 determining whether the one or more operand buffers 128 contains a corresponding one or more operands required for execution of the consumer loop instruction 120 (block 180). If not, processing loops back to block 180 to await the arrival of the required operands. However, if the reservation station segment 72 determines at block 180 that the one or more operand buffers 128 contains a corresponding one or more operands, the reservation station segment 72 provides the consumer loop instruction 120 and the corresponding one or more operands to the functional unit 152 for dataflow execution (block 182). The functional unit 152 may then provide the one or more reservation station segments 34(0)-34(X) with the following data: an execution result 160 of the consumer loop instruction 120; a loop iteration indicator 164 indicating a current loop iteration for the consumer loop instruction 120; and an RS tag 162 of the consumer loop instruction 120 (block 184).

The reservation station circuits according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

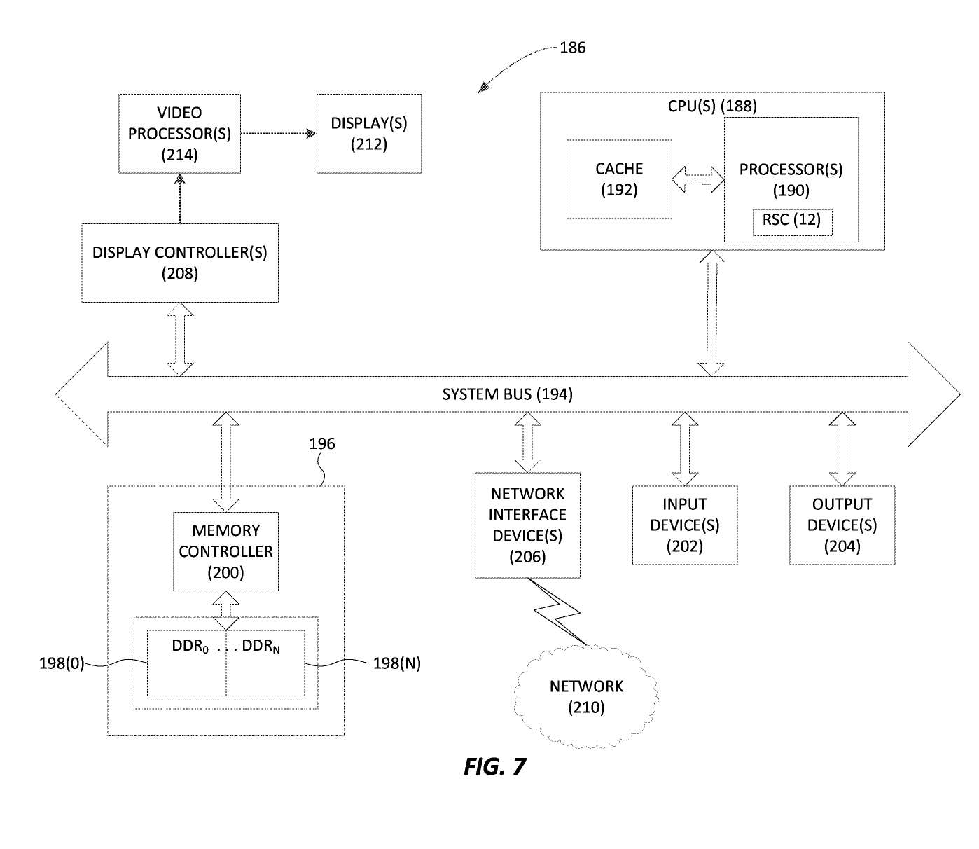

In this regard, FIG. 7 illustrates an example of a processor-based system 186 that can employ the reservation station circuit 12 illustrated in FIG. 1. In this example, the processor-based system 186 includes one or more central processing units (CPUs) 188, each including one or more processors 190 that may comprise the reservation station circuit (RSC) 12 of FIG. 1. The CPU(s) 188 may have cache memory 192 coupled to the processor(s) 190 for rapid access to temporarily stored data. The CPU(s) 188 is coupled to a system bus 194 and can intercouple master and slave devices included in the processor-based system 186. As is well known, the CPU(s) 188 communicates with these other devices by exchanging address, control, and data information over the system bus 194. For example, the CPU(s) 188 can communicate bus transaction requests to a memory system 196, which provides memory units 198(0)-198(N).

Other master and slave devices can be connected to the system bus 194. As illustrated in FIG. 7, these devices can include a memory controller 200, one or more input devices 202, one or more output devices 204, one or more network interface devices 206, and one or more display controllers 208, as examples. The input device(s) 202 can include any type of input device, including but not limited to input keys, switches, voice processors, etc. The output device(s) 204 can include any type of output device, including but not limited to audio, video, other visual indicators, etc. The network interface device(s) 206 can be any devices configured to allow exchange of data to and from a network 210. The network 210 can be any type of network, including but not limited to a wired or wireless network, a private or public network, a local area network (LAN), a wide local area network (WLAN), and the Internet. The network interface device(s) 206 can be configured to support any type of communications protocol desired.

The CPU(s) 188 may also be configured to access the display controller(s) 208 over the system bus 194 to control information sent to one or more displays 212. The display controller(s) 208 sends information to the display(s) 212 to be displayed via one or more video processor(s) 214, which processes the information to be displayed into a format suitable for the display(s) 212. The display(s) 212 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A reservation station circuit for enforcing loop-carried dependency (LCD) during dataflow execution of loop instructions, comprising
one or more reservation station segments, each comprising:
a loop instruction register configured to store a consumer loop instruction of a loop; and
one or more operand buffers each corresponding to an operand of the consumer loop instruction, each operand buffer of the one or more operand buffers comprising:
a producer identifier indicator indicative of a producer loop instruction of the operand;
an LCD offset indicator indicative of an LCD distance between the producer loop instruction and the consumer loop instruction; and
one or more operand buffer entries;
each reservation station segment of the one or more reservation station segments configured to:
receive a producer identifier corresponding to a value of the producer identifier indicator of an operand buffer of the one or more operand buffers of the one or more reservation station segments, and indicative of the producer loop instruction;
receive an execution result of the producer loop instruction;
receive a loop iteration indicator indicative of a current loop iteration for the producer loop instruction;
generate an operand buffer index based on the loop iteration indicator and the LCD offset indicator of the operand buffer; and
store the execution result as a first operand buffer entry of the one or more operand buffer entries of the operand buffer, the first operand buffer entry indicated by the operand buffer index.

2. The reservation station circuit of claim 1, wherein the LCD offset indicator of at least one operand buffer of the one or more operand buffers is indicative of the LCD distance being greater than one (1).

3. The reservation station circuit of claim 1, wherein each reservation station segment is configured to generate the operand buffer index based on the loop iteration indicator and the LCD offset indicator by generating a sum of a value of the loop iteration indicator and a value of the LCD offset indicator.

4. The reservation station circuit of claim 3, wherein each reservation station segment is further configured to set an initialization value for a second operand buffer entry of the one or more operand buffer entries of the operand buffer, the second operand buffer entry having an index less than the value of the LCD offset indicator.

5. The reservation station circuit of claim 1, further comprising a functional unit communicatively coupled to the one or more reservation station segments;
wherein each reservation station segment is further configured to:
determine that the one or more operand buffers contains a corresponding one or more operands required for execution of the consumer loop instruction; and
responsive to determining that the one or more operand buffers contains the corresponding one or more operands, providing the consumer loop instruction and the corresponding one or more operands to the functional unit for dataflow execution.

6. The reservation station circuit of claim 5, wherein:
each reservation station segment further comprises:
an identifier of the consumer loop instruction; and
a consumer loop iteration indicator indicating a current loop iteration for the consumer loop instruction; and
the functional unit is configured to provide to the one or more reservation station segments:
an execution result of the consumer loop instruction;
the consumer loop iteration indicator; and
the identifier of the consumer loop instruction.

7. The reservation station circuit of claim 1 integrated into an integrated circuit (IC).

8. The reservation station circuit of claim 1 integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

9. A reservation station circuit for enforcing loop-carried dependency (LCD) in dataflow execution of loop instructions, comprising:
a means for receiving, by a reservation station segment of one or more reservation station segments, a producer identifier corresponding to an operand buffer of one or more operand buffers of the reservation station segment, and indicative of a producer loop instruction;
a means for receiving, by the reservation station segment, an execution result of the producer loop instruction;
a means for receiving, by the reservation station segment, a loop iteration indicator indicative of a current loop iteration for the producer loop instruction;
a means for generating an operand buffer index based on the loop iteration indicator and an LCD offset indicator corresponding to the operand buffer, the LCD offset indicator indicative of an LCD distance between the producer loop instruction and a consumer loop instruction of the reservation station segment; and
a means for storing the execution result as a first operand buffer entry of the operand buffer, the first operand buffer entry indicated by the operand buffer index.

10. A method for enforcing loop-carried dependency (LCD) during dataflow execution of loop instructions, comprising:
receiving, by a reservation station segment of one or more reservation station segments, a producer identifier corresponding to an operand buffer of one or more operand buffers of the reservation station segment, and indicative of a producer loop instruction;
receiving, by the reservation station segment, an execution result of the producer loop instruction;
receiving, by the reservation station segment, a loop iteration indicator indicative of a current loop iteration for the producer loop instruction;
generating an operand buffer index based on the loop iteration indicator and an LCD offset indicator corresponding to the operand buffer, the LCD offset indicator indicative of an LCD distance between the producer loop instruction and a consumer loop instruction of the reservation station segment; and
storing the execution result as a first operand buffer entry of the operand buffer, the first operand buffer entry indicated by the operand buffer index.

11. The method of claim 10, wherein the LCD offset indicator is indicative of the LCD distance being greater than one (1).

12. The method of claim 10, wherein generating the operand buffer index based on the loop iteration indicator and the LCD offset indicator comprises generating a sum of a value of the loop iteration indicator and a value of the LCD offset indicator.

13. The method of claim 12, further comprising setting an initialization value for a second operand buffer entry of the operand buffer, the second operand buffer entry having an index less than the value of the LCD offset indicator.

14. The method of claim 10, further comprising:
determining that the one or more operand buffers contains a corresponding one or more operands required for execution of the consumer loop instruction; and
responsive to determining that the one or more operand buffers contains the corresponding one or more operands, providing the consumer loop instruction and the corresponding one or more operands to a functional unit for dataflow execution.

15. The method of claim 14, further comprising:
providing, to the one or more reservation station segments by the functional unit:
an execution result of the consumer loop instruction;
a consumer loop iteration indicator indicating a current loop iteration for the consumer loop instruction; and
an identifier of the consumer loop instruction.

16. A non-transitory computer-readable medium having stored thereon computer-executable instructions to cause a processor to implement a method for enforcing loop-carried dependency (LCD) during dataflow execution of loop instructions, comprising:
receiving, by a reservation station segment of one or more reservation station segments, a producer identifier corresponding to an operand buffer of one or more operand buffers of the reservation station segment, and indicative of a producer loop instruction;
receiving, by the reservation station segment, an execution result of the producer loop instruction;
receiving, by the reservation station segment, a loop iteration indicator indicative of a current loop iteration for the producer loop instruction;
generating an operand buffer index based on the loop iteration indicator and an LCD offset indicator corresponding to the operand buffer, the LCD offset indicator indicative of an LCD distance between the producer loop instruction and a consumer loop instruction of the reservation station segment; and
storing the execution result as a first operand buffer entry of the operand buffer, the first operand buffer entry indicated by the operand buffer index.

17. The non-transitory computer-readable medium of claim 16 having stored thereon the computer-executable instructions to cause the processor to implement the method, wherein the LCD offset indicator is indicative of the LCD distance being greater than one (1).

18. The non-transitory computer-readable medium of claim 16 having stored thereon the computer-executable instructions to cause the processor to implement the method, wherein generating the operand buffer index based on the loop iteration indicator and the LCD offset indicator comprises generating a sum of a value of the loop iteration indicator and a value of the LCD offset indicator.

19. The non-transitory computer-readable medium of claim 18 having stored thereon the computer-executable instructions to cause the processor to implement the method, further comprising setting an initialization value for a second operand buffer entry of the operand buffer, the second operand buffer entry having an index less than the value of the LCD offset indicator.

20. The non-transitory computer-readable medium of claim 16 having stored thereon the computer-executable instructions to cause the processor to implement the method, further comprising:
determining that the one or more operand buffers contains a corresponding one or more operands required for execution of the consumer loop instruction; and
responsive to determining that the one or more operand buffers contains the corresponding one or more operands, providing the consumer loop instruction and the corresponding one or more operands to a functional unit for dataflow execution.

21. The non-transitory computer-readable medium of claim 20 having stored thereon the computer-executable instructions to cause the processor to implement the method, further comprising:
providing, to the one or more reservation station segments by the functional unit:
an execution result of the consumer loop instruction;
a consumer loop iteration indicator indicating a current loop iteration for the consumer loop instruction; and
an identifier of the consumer loop instruction.
